(19) United States
(12) Patent Application Publication
(10) Pub. No.: US 2020/0132837 A1
(43) Pub. Date: Apr. 30, 2020

(54) OBSTACLE RECOGNITION DEVICE FOR VEHICLE DOOR AND VEHICLE DOOR WITH OBSTACLE RECOGNITION FUNCTION

(71) Applicant: AISIN SEIKI KABUSHIKI KAISHA, Kariya-shi (JP)

(72) Inventors: Tsubasa KAMIYA, Kariya-shi (JP); Masato SUGIYAMA, Kariya-shi (JP); Moritaka MIWA, Kariya-shi (JP); Nobuyasu MIWA, Kariya-shi (JP); Kosuke TSUKAO, Kariya-shi (JP)

(73) Assignee: AISIN SEIKI KABUSHIKI KAISHA, Kariya-shi (JP)

(21) Appl. No.: 16/660,866

(22) Filed: Oct. 23, 2019

(30) Foreign Application Priority Data
Oct. 26, 2018 (JP) 2018-201863

(51) Int. Cl. G01S 15/93; G01S 15/04

(52) U.S. Cl. CPC G01S 15/93; B60Q 9/008; G01S 15/04

(57) ABSTRACT

An obstacle recognition device for a vehicle door, includes: a sensor unit including a pair of transducers of an ultrasonic wave suitable for provision on a door that is opened by moving outward from a vehicle body; and a position recognition unit configured to recognize a relative position of an obstacle with respect to the door based on a reflected wave of an ultrasonic wave transmitted from the sensor unit and reflected by the obstacle. The pair of transducers are arranged at a predetermined interval, the sensor unit receives, by the pair of transducers, a reflected wave of an ultrasonic wave transmitted from at least one of the transducers toward a predetermined wave transmission area outside the vehicle body, and the position recognition unit recognizes the relative position of the obstacle with respect to the door based on respective reflected waves received by the pair of transducers.

### CROSS REFERENCE TO RELATED APPLICATIONS

This application is based on and claims priority under 35 U.S.C. § 119 to Japanese Patent Application 2018-201863, filed on Oct. 26, 2018, the entire contents of which are incorporated herein by reference.

### TECHNICAL FIELD

This disclosure relates to an obstacle recognition device for a vehicle door and a vehicle door with an obstacle recognition function.

### BACKGROUND DISCUSSION

JP 2005-249770A (Reference 1) discloses an ultrasonic distance measurement device using a so-called Time-of-Flight (TOF) method of measuring the distance to an obstacle by transmitting an ultrasonic wave and receiving a reflected wave thereof.

JP 2005-336934A (Reference 2) discloses an automatic opening/closing device for a vehicle door including an obstacle sensor (an example of an obstacle recognition device) using an ultrasonic wave provided on a vehicle body, a door opening/closing drive mechanism, and a controller for these. In the automatic opening/closing device for the vehicle door, the obstacle sensor detects the position of an obstacle in a movement track on the door opening direction side and on the door closing direction side, and the controller controls the door opening/closing drive mechanism so as not to exceed the openable range and the closeable range of the door set according to the detected position of the obstacle. The automatic opening/closing device for the vehicle door detects an obstacle existing on the door closing direction side to realize prevention of interference between the door and the obstacle at the time of the opening of the door and at the time of the closing of the door.

JP 2013-010384A (Reference 3) points out a problem that, since the movable area of a door is wide, it is necessary to provide multiple obstacle sensors in order to avoid the entire door from interference of the obstacle in the automatic opening/closing device disclosed in Reference 2. In order to solve this problem, Reference 3 discloses an automatic door opening device using a sonar and a laser sensor.

An obstacle recognition device for a vehicle door using an ultrasonic wave may detect the distance from the obstacle recognition device in the position of an obstacle, but may not recognize a relative positional relationship between the obstacle recognition device and the obstacle only with the detected distance. Therefore, the conventional obstacle recognition device has a problem that it is not possible to appropriately prevent interference between the door and the obstacle. Further, when a laser sensor is used, there is a problem that the device cost increases.

Thus, a need exists for an obstacle recognition device and a door with an obstacle recognition function which are not susceptible to the drawback mentioned above.

### SUMMARY

A feature of an obstacle recognition device for a vehicle door according to an aspect of this disclosure resides in that the obstacle recognition device includes a sensor unit including a pair of transducers of an ultrasonic wave suitable for provision on a door that is opened by moving outward from a vehicle body, and a position recognition unit configured to recognize a relative position of an obstacle with respect to the door based on a reflected wave of an ultrasonic wave transmitted from the sensor unit and reflected by the obstacle, and the pair of transducers are arranged at a predetermined interval, the sensor unit receives, by the pair of transducers, a reflected wave of an ultrasonic wave transmitted from at least one of the transducers toward a predetermined wave transmission area outside the vehicle body, and the position recognition unit recognizes the relative position of the obstacle with respect to the door based on respective reflected waves received by the pair of transducers.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an explanatory view of an overall configuration of a door with an obstacle recognition function and a first recognition operation;

FIG. 2 is an explanatory view of a second recognition operation;

FIG. 3 is a rear cross-sectional view for explaining a relationship between a door with an obstacle recognition function, a wave transmission area, and an obstacle;

FIG. 4 is an explanatory view of a state where an obstacle recognition device and a door with an obstacle recognition function are provided on a vehicle;

FIG. 5 is a view for explaining an obstacle recognition method according to First Example;

FIG. 6 is another explanatory view of the first recognition operation;

FIG. 7 is another explanatory view of the second recognition operation; and

FIG. 8 is a view for explaining an obstacle recognition method according to Second Example.

### DETAILED DESCRIPTION

A feature of an obstacle recognition device for a vehicle door according to an aspect of this disclosure resides in that the obstacle recognition device includes a sensor unit including a pair of transducers of an ultrasonic wave suitable for provision on a door that is opened by moving outward from a vehicle body, and a position recognition unit configured to recognize a relative position of an obstacle with respect to the door based on a reflected wave of an ultrasonic wave transmitted from the sensor unit and reflected by the obstacle, and the pair of transducers are arranged at a predetermined interval, the sensor unit receives, by the pair of transducers, a reflected wave of an ultrasonic wave transmitted from at least one of the transducers toward a predetermined wave transmission area outside the vehicle body, and the position recognition unit recognizes the relative position of the obstacle with respect to the door based on respective reflected waves received by the pair of transducers.

Hereinafter, among the pair of transducers of an ultrasonic wave (so-called ultrasonic transducers), one transducer is referred to as a first transducer and the other transducer is referred to as a second transducer. According to the above configuration, for example, by receiving a reflected wave of an ultrasonic wave transmitted from the first transducer and reflected from an obstacle by each of the first transducer and the second transducer, the position recognition unit may obtain, based on the time from the start of transmission of the ultrasonic wave to reception of the ultrasonic wave and the propagation speed of the ultrasonic wave, the distance between the first transducer and the obstacle (hereinafter referred to as a first distance) and the distance between the second transducer and the obstacle (hereinafter referred to as a second distance)(so-called a TOF method). Here, the distance between the first transducer and the second transducer (hereinafter referred to as the distance between sensors) is known as a predetermined interval. Accordingly, the position recognition unit may recognize the relative position of the obstacle with respect to the sensor unit such as the distance between the sensor unit and the obstacle by trilateration based on the first distance, the second distance, and the distance between sensors. That is, it is possible to recognize the relative position of the obstacle with respect to the door (hereinafter simply referred to as a vehicle door) that is opened by moving outward from the vehicle body on which the sensor unit is provided. Therefore, it is possible to provide the obstacle recognition device which may appropriately prevent interference between the vehicle door and the obstacle.

Another feature of the obstacle recognition device for the vehicle door according to the aspect of this disclosure resides in that the pair of transducers are arranged on an outer peripheral portion of the door along an outer periphery of the door.

According to the above configuration, since the distance between the outer peripheral portion (the end portion along the outer periphery) of the vehicle door and the obstacle may be recognized, it is possible to provide the obstacle recognition device which may prevent interference between an obstacle such as a wall and the outer peripheral portion of the vehicle door having a high possibility of hitting the obstacle.

Another feature of the obstacle recognition device for the vehicle door according to the aspect of this disclosure resides in that the pair of transducers are arranged on a lower edge of the outer peripheral portion of the door and the wave transmission area is set so as to overlap with an opening/closing area where the door moves by an opening/closing operation.

A major obstacle expected to interfere with the vehicle door when the door is opened and closed, e.g., most of such as a road sign, a building wall, and another vehicle, are grounded to the ground. Therefore, most of obstacles are located close to the lower end portion of the vehicle door. Accordingly, by arranging the pair of transducers on the lower edge (lower end portion) of the outer peripheral portion of the vehicle door and overlapping the wave transmission area with the opening/closing area as in the above configuration, it is possible to recognize a major obstacle in the opening/closing area where there is a possibility of interference when the vehicle door is opened and closed. Therefore, it is possible to prevent interference between the vehicle door and the major obstacle.

Another feature of the obstacle recognition device for the vehicle door according to the aspect of this disclosure resides in that the pair of transducers are arranged on a lower edge of the outer peripheral portion of the door and the wave transmission area is set so as not to overlap with an area below an opening/closing area where the door moves by an opening/closing operation.

As described above, the major obstacle expected to interfere with the vehicle door when the door is opened and closed is grounded to the ground. An object that exists in an area below the opening/closing area and does not overlap with the opening/closing area does not interfere with the vehicle door when the vehicle door is opened and closed. Accordingly, by arranging the pair of transducers on the lower edge (lower end portion) of the outer peripheral portion of the vehicle door and setting the wave transmission area so as not to overlap with the area below the opening/closing area where the door moves, it is possible to recognize an obstacle in the opening/closing area by overlapping the wave transmission area with at least the opening/closing area close to the lower end portion of the vehicle door, and to prevent an object existing only in the area below the opening/closing area, i.e., the area where there is no interference when the vehicle door is opened and closed from being erroneously recognized as an obstacle.

Another feature of the obstacle recognition device for the vehicle door according to the aspect of this disclosure resides in that a transmission direction of each transducer is set so as to be inclined upward from a horizontal direction when viewed from the transducer.

The transmission direction of the transducer is the direction in which the transducer transmits an ultrasonic wave. According to the above configuration, the wave transmission area is set so as to overlap with the area where the vehicle door is opened and closed and is also set so as not to overlap with the area below the area where the vehicle door is opened and closed. Therefore, it is possible to recognize an obstacle in the area where the vehicle door is opened and closed, the obstacle having a possibility of interference when the vehicle door is opened and closed. On the other hand, it is possible to prevent an object in the area below the area where the door is opened and closed from being erroneously recognized as an obstacle.

A feature of a vehicle door with an obstacle recognition function according to another aspect of this disclosure resides in that the vehicle door includes a sensor unit including a pair of transducers of an ultrasonic wave and a position recognition unit configured to recognize a relative position of an obstacle based on a reflected wave of an ultrasonic wave transmitted from the sensor unit and reflected by the obstacle, the pair of transducers are arranged at a predetermined interval, in which the sensor unit receives, by the pair of transducers, a reflected wave of an ultrasonic wave transmitted from at least one of the transducers toward a predetermined wave transmission area outside a vehicle body, and the position recognition unit recognizes the relative position of the obstacle based on respective reflected waves received by the pair of transducers.

According to the above configuration, the same action effects as those in the above-described obstacle recognition device may be obtained.

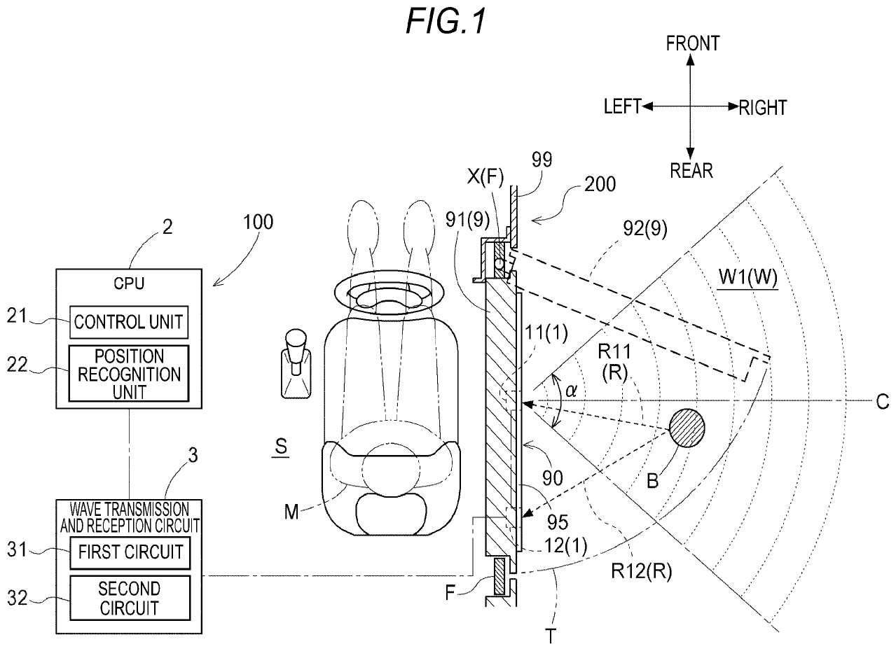

An obstacle recognition device for a vehicle door and a vehicle door with an obstacle recognition function according to an embodiment disclosed here will be described based on FIGS. 1 to 8.

As illustrated in FIG. 1, a vehicle 200 includes a door 9 (an example of a door or an example of a door with an obstacle recognition function) or an outer plate 99 which partitions the inside and the outside of the vehicle 200 in a riding opening 90 of a vehicle room S which is a space inside the vehicle 200 into which an occupant M gets. In addition, In FIG. 1, the front side in the traveling direction of the vehicle 200 is referred to as the front and the reverse thereof is the rear, and the right hand side of the occupant M seated at the front side in the traveling direction is referred to as the right and the reverse thereof is referred to as the left. The inside refers to the vehicle room S side when viewed from the door 9 or the outer plate 99. The outside refers to the outside of the vehicle room S when viewed from the door 9 or the outer plate 99.

The door 9 includes any of side doors (front doors and rear doors) provided on the left and right sides of the vehicle 200 or a back door provided on the rear of the vehicle 200. FIG. 1 describes by way of example a case where the door 9 is a right front door of the vehicle 200. In a case where the door 9 is a left front door of the vehicle 200, the door is plane-symmetric with the right front door. Hereinafter, a case where the door 9 is a right front door of the vehicle 200 will be described.

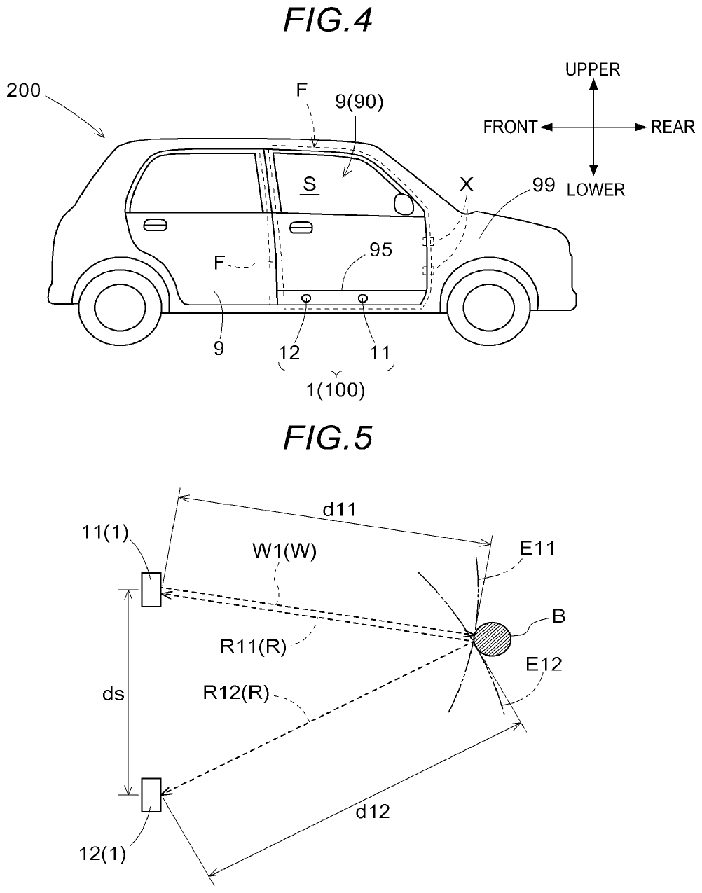

As illustrated in FIGS. 1 and 4, the door 9 is an entrance door provided in the riding opening 90 of the vehicle room S. The door 9 includes a decorative plate 95 (so-called garnish) illustrated in FIGS. 1, 2, and 4 on the lower edge (lower end portion) of the outer peripheral portion outside the vehicle 200. In FIG. 1, the door 9 which is closed is illustrated as a closed door 91 in a closed state. Further, the door 9 which is opened by being swung to the maximum extent is illustrated as an open door 92 by a broken line. The riding opening 90 has a frame F forming an opening which becomes the riding opening 90 inside the outer plate 99. The frame F is fixed to a vehicle body frame (not illustrated) of the vehicle 200.

As illustrated in FIG. 1, the door 9 includes a sensor system 100 (an example of an obstacle recognition device) which recognizes an obstacle B existing in an area where the door 9 moves by an opening/closing operation when the door 9 moves outward from the outer plate 99 or the frame F (an example of a frame body) in a state where the outer surface of the door 9 is flush with the outer plate 99 (in a state of the closed door 91) and reaches a state of the open door 92. In addition, the area where the door 9 moves by the opening/closing operation is an area inside a track T when the door 9 is opened and closed as to be described later. Hereinafter, the area where the door 9 moves by the opening/closing operation is simply referred to as an opening/closing area.

The door 9 is pivotally supported by a hinge (not illustrated) fixed to the frame F and is swingable in the horizontal direction. FIG. 1 illustrates a case where the front end side of the door 9 is pivotally supported by the frame F on the front end side. The door 9 is opened by being swung about a shaft X pivotally supported by the frame Fx as a rotation axis. In a plan view, when the door 9 is swung about the shaft X as a rotation axis from a state of the closed door 91 to a state of the open door 92, the track drawn by the rear end of the door 9 moving outward is the track T. The area surrounded by the closed door 91, the open door 92, and the track T corresponds to the opening/closing area.

The sensor system 100 includes a sensor unit 1 which may transmit and receive an ultrasonic wave, a wave transmission and reception circuit 3 which transmits an electric signal for transmission of an ultrasonic wave W to the sensor unit 1 and receives an electric signal when the sensor unit 1 receives an ultrasonic wave, and a CPU 2 which controls an overall operation of the sensor system 100. The CPU 2 includes a position recognition unit 22 which recognizes a relative position of the obstacle B and a control unit 21 which issues an operation instruction to the sensor unit 1 or the wave transmission and reception circuit 3. The sensor unit 1 is provided on the lower end of the door 9.

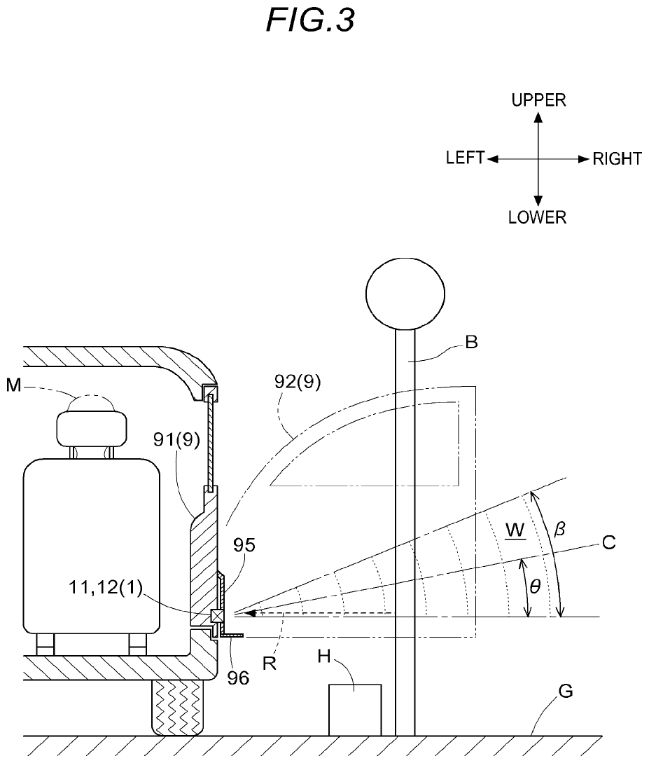

The sensor unit 1 is a transducer unit including a first transducer 11 and a second transducer 12 (each being an example of a transducer). As illustrated in FIGS. 1, 3, and 4, the sensor unit 1 is provided on the edge of the lower end of the door 9 (the lower end portion of the door 9) in the outer peripheral portion of the door 9. The sensor unit 1 is provided in the vicinity of the lower end portion of the decorative plate 95 which is the lower end portion of the door 9. Further, the sensor unit 1 is disposed at a position biased to the rear side (opening/closing side) of the door 9. As illustrated in FIGS. 1 and 3, the sensor unit 1 is provided in an exposed state so as to be flush with the surface of the decorative plate 95. As illustrated in FIG. 3, a partition plate 96 is provided on the lower end of the decorative plate 95 so as to extend outward from the lower end in parallel to the ground G (parallel to the horizontal direction).

The first transducer 11 and the second transducer 12 are ultrasonic transducers that may be electrically connected to at least the wave transmission and reception circuit 3 to transmit and receive an ultrasonic wave. The first transducer 11 and the second transducer 12 include a piezoelectric element such as piezoelectric ceramics or a diaphragm (not illustrated) which amplifies distortion of the piezoelectric element to propagate vibration to the air and transfers the vibration of the air to the piezoelectric element as distortion.

The first transducer 11 and the second transducer 12 are connected to at least the wave transmission and reception circuit 3 to construct a so-called sonar circuit. Each of the first transducer 11 and the second transducer 12 is combined with the wave transmission and reception circuit 3 to realize a function of transmitting an ultrasonic wave having a predetermined frequency or a function of receiving an ultrasonic wave having a frequency approximate to the transmitted ultrasonic wave.

As illustrated in FIG. 1, the first transducer 11 and the second transducer 12 may transmit the ultrasonic wave W having a predetermined frequency toward a predetermined direction outside the vehicle 200 by vibration of the piezoelectric element thereof. The first transducer 11 and the second transducer 12 may receive an ultrasonic wave having a frequency approximate to the ultrasonic wave W which may be transmitted (e.g., a reflected wave R of the ultrasonic wave W) via the piezoelectric element thereof. Hereinafter, a terminal portion that transmits and receives an ultrasonic wave such as the piezoelectric element or the diaphragm of the first transducer 11 or the second transducer 12 is simply referred to as a terminal.

As illustrated in FIG. 1, when receiving a predetermined electric signal from the wave transmission and reception circuit 3, the first transducer 11 and the second transducer 12 transmit the ultrasonic wave W having a predetermined frequency (e.g., the frequency being around 40 kHz). VVhen receiving an ultrasonic wave having a frequency approximate to the transmitted ultrasonic wave, i.e., the reflected wave R of the ultrasonic wave W, the first transducer 11 and the second transducer 12 transmit an electric signal corresponding to the received ultrasonic wave to the wave transmission and reception circuit 3.

As illustrated in FIGS. 1 to 3, the first transducer 11 and the second transducer 12 are arranged side by side in the longitudinal direction on the lower end portion of the door 9. The first transducer 11 and the second transducer 12 are arranged with a predetermined interval (e.g., 20 cm to 40 cm as the predetermined interval).

The decorative plate 95 has, for example, a through-hole formed from the inside to the outside, and the terminal of the first transducer 11 or the second transducer 12 is fitted into the through-hole and is fixed outward.

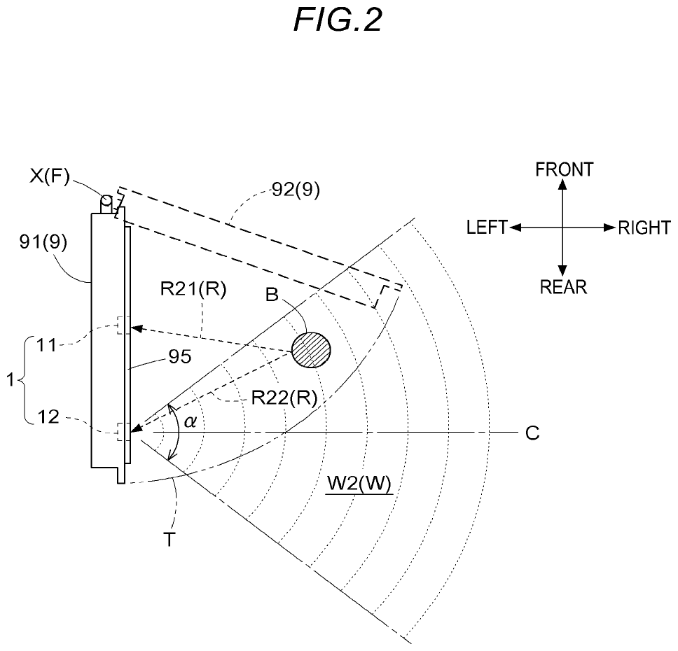

As illustrated in FIGS. 1 and 2, the first transducer 11 is disposed between the rear end of the door 9 and the longitudinal center of the door 9.

The second transducer 12 is disposed behind the first transducer 11. The first transducer 11 and the second transducer 12 are provided at the same height when viewed from the ground G (see FIG. 3).

In a plan view of the vehicle 200, as illustrated in FIGS. 1 and 2, a wave transmission area of the ultrasonic wave W is set to a fan shape having a central angle a (e.g., α=100 degrees) which is set to be longitudinally plane-symmetrical with respect to the center line C. As illustrated in FIG. 3, the wave transmission area of the ultrasonic wave W is set to a fan shape having a central angle β (e.g., β=30 degrees) which is set to be vertically plane-symmetrical with respect to the center line C. The central angle a in the wave transmission area of the ultrasonic wave W is set larger than the central angle β. That is, the vertical cross section in the longitudinal direction of the wave transmission area of the ultrasonic wave W is set to an ellipse or an oval having a long axis along the longitudinal direction and is set to have a low directivity in the vertical direction. Since the directivity in the vertical direction is set to be low as described above, when recognizing the relative position of the obstacle B with respect to the sensor unit 1, a detection error of a positional relationship between the sensor unit 1 and the obstacle B (the distance in the horizontal direction between the sensor unit 1 and the obstacle B) may be reduced and thus, the relative position of the obstacle B may be recognized with high accuracy.

As illustrated in FIGS. 1 to 3, the wave transmission area of the ultrasonic wave W transmitted by each of the first transducer 11 and the second transducer 12 overlaps with the opening/closing area. Assuming that a virtual line passing through the center of the cross section intersecting the wave transmission direction of the ultrasonic wave W in the wave transmission area of the ultrasonic wave W is the center line C, as illustrated in FIGS. 1 and 2, the center line C is set to the direction along the transverse direction. The direction in which the center line C extends usually follows the wave transmission direction of the ultrasonic wave W. In order to set the center line C in the direction along the transverse direction, the terminal of the transducer is mounted toward the outside of the vehicle 200. In addition, the wave transmission area of the ultrasonic wave W of the first transducer 11 or the second transducer 12 refers to the range in which the reflected wave R of the ultrasonic wave W transmitted by the first transducer 11 or the second transducer 12 may be detected by both the first transducer 11 and the second transducer 12.

As illustrated in FIG. 3, the center line C is set so as to be inclined upward from the direction parallel to the ground G (horizontal direction) by an inclination angle θ (e.g., θ=12 degrees), and the wave transmission direction of the ultrasonic wave W is set so as to be inclined upward when viewed from the first transducer 11 or the second transducer 12. For example, the inclination angle θ is set to about half of the central angle 13. In order to set the center line C (the wave transmission direction of the ultrasonic wave W) so as to be inclined slightly upward from the direction parallel to the ground G, the terminals of the first transducer 11 and the second transducer 12 are provided in the direction inclined slightly upward from the direction parallel to the ground G. Thus, the wave transmission area of the ultrasonic wave W transmitted by each of the first transducer 11 and the second transducer 12 is set so as not to overlap with an area below the opening/closing area.

The lateral outer area of the terminals of the first transducer 11 and the second transducer 12 and the partition plate 96 overlap each other in the vertical direction. In other words, the lower side of the wave transmission area of the ultrasonic wave W in the vicinity of the terminals of the first transducer 11 and the second transducer 12 is shielded by the partition plate 96 and is outside the wave transmission area.

In this way, since the wave transmission area of the ultrasonic wave W transmitted by each of the first transducer 11 and the second transducer 12 overlaps with the opening/closing area, it is possible to recognize the obstacle B overlapping with the opening/closing area. On the other hand, since the wave transmission area of the ultrasonic wave W transmitted by each of the first transducer 11 and the second transducer 12 is set so as not to overlap with the area below the opening/closing area, it is possible to prevent an object H that does not interfere the door 9 when the door 9 is opened and closed in the area below the opening/closing area and thus, is not an obstacle from being erroneously recognized as the obstacle B. Further, since the lower side of the wave transmission area of the ultrasonic wave W in the vicinity of the terminals of the first transducer 11 and the second transducer 12 is shielded by the partition plate 96, it is possible to prevent leakage of the ultrasonic wave W to the area below the opening/closing area, thereby preventing erroneous recognition of the object H that is not an obstacle with high accuracy. FIG. 3 illustrates a case where the obstacle B fixed to the ground G such as a road sign extends upward and overlaps with the opening/closing area of the door 9. In addition, an example of the object H that is in the area below the opening/closing area of the door 9 and, thus is not an obstacle may be a short kerb on the side of a road.

As illustrated in FIG. 1, the wave transmission and reception circuit 3 includes a first circuit 31 and a second circuit 32 as electric circuits for wave transmission and reception which correspond respectively to the first transducer 11 and the second transducer 12. The first circuit 31 and the second circuit 32 are electric circuit units having, for example, a modulator, an oscillator, or a detector (not illustrated).

The wave transmission and reception circuit 3 transmits electric signals separately for transmitting the ultrasonic wave W to each of the first transducer 11 and the second transducer 12 of the sensor unit 1 based on an instruction of the control unit 21. The first transducer 11 and the second transducer 12 transmit an ultrasonic wave by the first circuit 31 and the second circuit 32 corresponding thereto respectively.

The wave transmission and reception circuit 3 receives electric signals by the first circuit 31 and the second circuit 32 when the first transducer 11 and the second transducer 12 of the sensor unit 1 respectively receive ultrasonic waves separately, and transmits a signal indicating that the electric signals have been received to the position recognition unit 22. When transmitting the signal indicating that the electric signals have been received to the position recognition unit 22, the wave transmission and reception circuit 3 determines which of the first transducer 11 and the second transducer 12 has received the electric signal, and transmits the signal indication reception of the electric signal.

The CPU 2 is a central processing device of the sensor system 100. The CPU 2 includes the position recognition unit 22 and the control unit 21. Functions of the position recognition unit 22 and the control unit 21 are realized by software stored in a storage medium such as a flash memory, and the position recognition unit 22 and the control unit 21 function according to a predetermined program or the like.

The control unit 21 is a functional unit that issues an operation instruction to the sensor unit 1 or the wave transmission and reception circuit 3 according to a predetermined program or the like. For example, when detecting that the occupant M or a central control device (not illustrated) such as an ECU of the vehicle 200 tries to open the door 9 or opens the door 9, the control unit 21 starts recognition of the obstacle B by the sensor system 100. For example, the control unit 21 detects that the occupant M touches a door knob for opening/closing the door 9 by a human detection sensor provided on the door knob, predicts, by the detection, that the occupant M is about to open the door 9 or opens the door 9, and starts recognition of the obstacle B by the sensor system 100. In addition, the control unit 21 may continue recognition of the obstacle B while the occupant M is opening the door 9.

When starting recognition of the obstacle B by the sensor system 100, the control unit 21 instructs the wave transmission and reception circuit 3 to transmit the ultrasonic wave W to the sensor unit 1. Hereinafter, that the control unit 21 instructs the wave transmission and reception circuit 3 to transmit an ultrasonic wave to the sensor unit 1 is simply described as instructing to transmit the ultrasonic wave W.

When instructing to transmit the ultrasonic wave W, the control unit 21 alternately instructs the first transducer 11 and the second transducer 12 to transmit the ultrasonic wave W having a predetermined burst length (e.g., a length of 0.2 milliseconds) at a predetermined interval (e.g., every 50 milliseconds). While continuing recognition of the obstacle B, the control unit 21 continuously instructs to transmit the ultrasonic wave W. While the control unit 21 continuously instructs to transmit the ultrasonic wave W, the first transducer 11 and the second transducer 12 alternately repeat transmission of the ultrasonic wave W having a predetermined burst length.

The position recognition unit 22 is a functional unit that recognizes a relative position of the obstacle B based on the reflected wave R of the ultrasonic wave W transmitted by the first transducer 11 or the second transducer 12 and reflected by the obstacle B. Further, the position recognition unit 22 is a functional unit that predicts interference such as a collision between the obstacle B and the door 9 when the door 9 is opened and notifies the control unit 21 of the predicted result in a case where the recognized relative position of the obstacle B overlaps with the opening/closing area.

The position recognition unit 22 calculates the distance between each of the first transducer 11 and the second transducer 12 and the obstacle B by a so-called TOF method based on a time difference between the timing when the first transducer 11 or the second transducer 12 transmits the ultrasonic wave W and the timing when the first transducer 11 or the second transducer 12 receives the reflected wave R and based on the speed of sound that is the propagation speed of the ultrasonic wave, and recognizes the relative position of the obstacle B by a trilateration method. Details will be described later.

When recognizing the relative position of the obstacle B, i.e., when predicting interference such as a collision between the obstacle B and the door 9 when the door 9 is opened, the position recognition unit 22 notifies the control unit 21 of the predicted result. The control unit 21 which has received the notification may notify the occupant M of interference such as a collision between the obstacle B and the door 9 by a notification unit (not illustrated) such as a speaker or a warning lamp provided in the vehicle room S. Further, for example, the control unit 21 which has received the notification may also prohibit the opening and closing of the door 9 by a brake system (not illustrated) provided on the door 9 to prevent the opening and closing of the door 9.

### [As for Recognition Method of Relative Position of Obstacle]

### EXAMPLE 1

A specific example of a recognition method of the relative position of the obstacle B by the position recognition unit 22 will be described. Hereinafter, a case where the obstacle B is an object having a small width in the longitudinal direction such as a road sign will be described by way of example.

Hereinafter, an operation (see FIGS. 1 and 5) in which the first transducer 11 transmits the ultrasonic wave W (ultrasonic wave W1) to recognize the obstacle B may be referred to as a first recognition operation. An operation (see FIG. 2) in which the second transducer 12 transmits the ultrasonic wave W (ultrasonic wave W2) to recognize the obstacle B may be referred to as a second recognition operation.

The first recognition operation will be described. As illustrated in FIG. 5, the position recognition unit 22 calculates a distance d11 between the first transducer 11 and the obstacle B by a TOF method based on the speed of sound and the time from when the first transducer 11 transmits an ultrasonic wave W1 to when the first transducer 11 receives a reflected wave R11 of the ultrasonic wave W1 reflected by the obstacle B.

The position recognition unit 22 calculates the total distance of a distance d12 between the second transducer 12 and the obstacle B and the distance d11 (the distance from the first transducer 11 to the second transducer 12 via the obstacle B) by a TOF method based on the speed of sound and the time from when the first transducer 11 transmits the ultrasonic wave W1 to when the first transducer 12 receives a reflected wave R12 of the ultrasonic wave W1 reflected by the obstacle B. Thereafter, the position recognition unit 22 calculates the distance d12 as a difference by subtracting the distance d11 from the total distance.

The position recognition unit 22 recognizes the relative position of the obstacle B by a trilateration method from the intersection of a virtual circle E11 centered on the terminal of the first transducer 11 and a virtual ellipse E12 focused on the terminal of the second transducer 12 spaced apart from the terminal of the first transducer 11 by a distance ds.

The second recognition operation will be described. As illustrated in FIG. 2, the second recognition operation is different from the first recognition operation in that a relative relationship between the first transducer 11 and the second transducer 12 is reversed, and the other processing thereof is performed in the same manner. That is, the second recognition operation recognizes the relative position of the obstacle B as the second transducer 12 transmits an ultrasonic wave and the first transducer 11 receives a reflected wave of the ultrasonic wave reflected by the obstacle B. A detailed description of the second recognition operation will be omitted.

The second recognition operation recognizes the relative position of the obstacle B by trilateration by executing the same processing as in the first recognition operation described above. The distance between the first transducer 11 and the obstacle B detected by the second recognition operation is equal to the distance d11 detected by the first recognition operation. The distance between the second transducer 12 and the obstacle B detected by the second recognition operation is equal to the distance d12 detected by the first recognition operation. The distance from the second transducer 12 to the first transducer 11 via the obstacle B detected by the second recognition operation is equal to the sum of the distance d11 and the distance d12 detected by the first recognition operation. In addition, the respective distances detected by the second recognition operation and the respective distance detected by the first recognition operation are equal to each other when the second recognition operation is executed at the same position as when the door 9 executes the first recognition operation (without movement of the door 9 by opening or closing) and under the same environment (e.g., temperature or ambient noise) as when and the first transducer 11 and the second transducer 12 execute the first recognition operation.

In this way, the position recognition unit 22 recognizes the relative position of the obstacle B in both the first recognition operation and the second recognition operation. Thus, the position recognition unit 22 may recognize the relative position of the obstacle B with high accuracy. As a result, interference between the door 9 and the obstacle B may be prevented appropriately.

### EXAMPLE 2

This example is different in that the obstacle B of Example 1 is an object having a small width in the longitudinal direction such as a road sign, whereas the obstacle B of this example is an object having a large width in the longitudinal direction (hereinafter, referred to as a wall body) such as a building wall or a fence of a house.

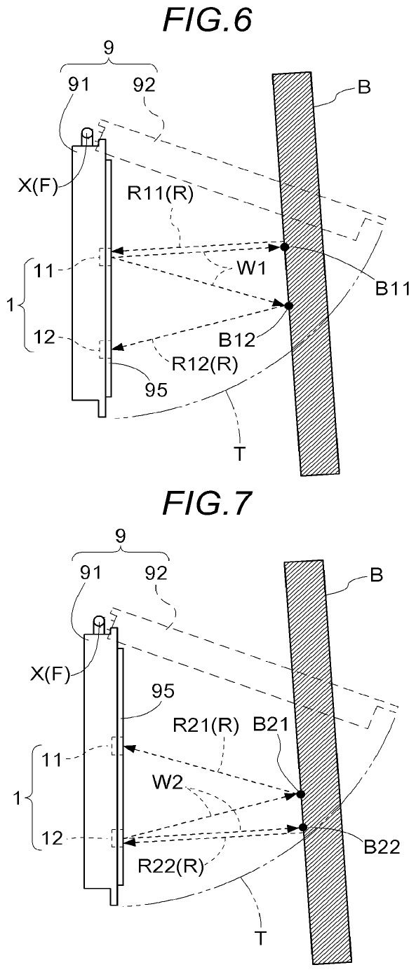

As illustrated in FIG. 6, in the first recognition operation, the reflected wave R11 is reflected at a position B11 and is introduced into the first transducer 11. The reflected wave R12 is reflected at a position B12 behind the position B11 and is introduced into the second transducer 12.

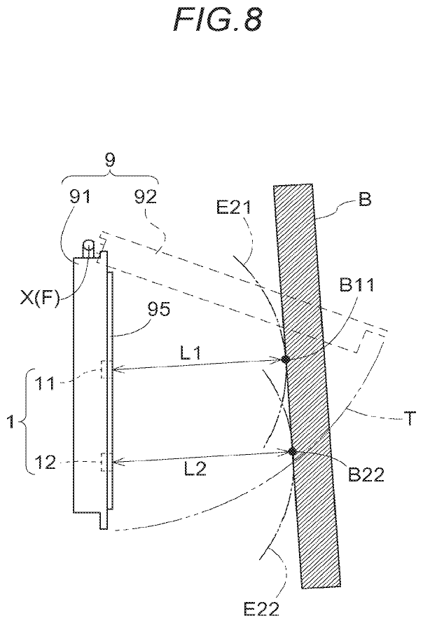

The position recognition unit 22 executes the first recognition operation to calculate a distance L1 between the first transducer 11 and the position B11 (see FIG. 8) and the distance from the first transducer 11 to the second transducer 12 via the position B12 by a TOF method.

As illustrated in FIG. 7, in the second recognition operation, a reflected wave R21 is reflected at a position B21 and is introduced into the first transducer 11. A reflected wave R22 is reflected at a position B22 behind the position B21 and is introduced into the second transducer 12.

The position recognition unit 22 executes the second recognition operation to calculate a distance L2 between the second transducer 12 and the position B22 (see FIG. 8) and the distance from the second transducer 12 to the first transducer 11 via the position B21 by a TOF method.

In this example, unlike Example 1, the distance from the second transducer 12 to the first transducer 11 via the position B21 (obstacle B) recognized by execution of the second recognition operation does not match the total distance of the distance L1 between the first transducer 11 and the position B11 detected by execution of the first recognition operation and the distance L2 between the second transducer 12 and the position B22 in the second recognition operation. The position recognition unit 22 recognizes the obstacle B as a wall body based on this mismatching information.

When recognizing the obstacle B as a wall body, the position recognition unit 22 recognizes the position of the obstacle B as a wall body based on the distance L1 between the first transducer 11 and the position B11 detected by execution of the first recognition operation and the distance L2 between the second transducer 12 and the position B22 detected by execution of the second recognition operation. More specifically, as illustrated in FIG. 8, the position recognition unit 22 recognizes the position of the obstacle B as a wall body that is in contact with both arcs of a virtual circle E21 that is an arc centered on the first transducer 11 and having a radius equal to the distance L1 between the first transducer 11 and the position B11 and a virtual circle E22 that is an arch centered on the second transducer 12 and having a radius equal to the distance L2 between the second transducer 12 and the position B22.

In this way, the position recognition unit 22 may recognize the relative position of the obstacle B with high accuracy since it recognizes whether the obstacle B is an object having a small width or a large width in the longitudinal direction. As a result, interference between the door 9 and the obstacle B may be prevented appropriately.

As described above, it is possible to provide an obstacle recognition device and a door with an obstacle recognition function which may appropriately prevent interference between the door and an obstacle.

### Other Embodiments

(1) The above embodiment has described by way of example a case where the door 9 on which the sensor unit 1 is provided is a right front door of the vehicle 200. However, the door 9 on which the sensor unit 1 is provided is not limited to the right front door. The door 9 on which the sensor unit 1 is provided may be a left front door or may be a left or right rear door. Further, the door 9 may be a back door of the vehicle 200.

(2) The above embodiment has described by way of example a case where the sensor unit 1 is provided inside the decorative plate 95 on the lower end portion of the door 9. However, the position where the sensor unit 1 is provided is not limited to this form. For example, when the decorative plate 95 is not provided on the door 9, the sensor unit 1 may be fixed to the lateral outer side on the lower end portion of the door 9.

(3) The above embodiment has described by way of example a case where the sensor unit 1 is provided on the lower end portion which is the end portion of the door 9. However, the position where the sensor unit 1 is provided is not limited to this form. For example, the sensor unit 1 may be provided on the rear end portion of the door 9 (the end portion far from the hinge of the door 9) so that the first transducer 11 and the second transducer 12 are arranged in the vertical direction.

(4) The above embodiment has described by way of example a case where the sensor unit 1 is provided on the end portion of the door 9. However, the position where the sensor unit 1 is provided is not limited to the end portion of the door 9. For example, the sensor unit 1 may be provided inside a door knob outside the door 9.

(5) The above embodiment has described a case where, in order to set the wave transmission direction of the ultrasonic wave W so as to be inclined slightly upward from the direction parallel to the ground G, the terminals of the first transducer 11 and the second transducer 12 are provided so as to be inclined slightly upward from the direction (horizontal direction) parallel to the ground G. However, the terminals of the first transducer 11 and the second transducer 12 are not limited to a case where they are provided so as to be inclined slightly upward from the direction parallel to the ground G. The terminals of the first transducer 11 and the second transducer 12 may be provided in the direction parallel to the ground G.

(6) The above embodiment has described that the wave transmission and reception circuit 3 includes the first circuit 31 and the second circuit 32 as electric circuits for wave transmission and reception which correspond respectively to the first transducer 11 and the second transducer 12 and that the first transducer 11 and the second transducer 12 are independently driven by the first circuit 31 and the second circuit 32 corresponding respectively thereto to transmit the ultrasonic wave W. However, the wave transmission and reception circuit 3 is not limited to a case where it includes the electric circuits to transmit the ultrasonic wave W to both the first transducer 11 and the second transducer 12. That is, the wave transmission and reception circuit 3 is not limited to a case where both the first transducer 11 and the second transducer 12 may transmit the ultrasonic wave W.

For example, the wave transmission and reception circuit 3 may include the first circuit 31 or the second circuit 32 which may transmit and receive the wave to and from the first transducer 11 or the second transducer 12 and the second circuit 32 or the first circuit 31 which may only receive the wave from the second transducer 12 or the first transducer 11. By configuring the wave transmission and reception circuit 3 in this manner, costs may be reduced by a simplified configuration of the wave transmission and reception circuit 3.

(7) The above-described embodiment has described a case where the partition plate 96 is provided on the lower end of the decorative plate 95, but the partition plate 96 may not necessarily be provided.

In addition, the configuration disclosed in the above-described embodiments (including other embodiments as below) may be applied in combination with the configurations disclosed in other embodiments unless contradiction. Further, the embodiments disclosed here may be merely given by way of example, may not be limited thereto, and may be appropriately modified within the range not departing from the object of the disclosure.

This disclosure may be applied to an obstacle recognition device and a door with an obstacle recognition function which may appropriately prevent interference between the door and an obstacle.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An obstacle recognition device for a vehicle door, comprising:
a sensor unit including a pair of transducers of an ultrasonic wave suitable for provision on a door that is opened by moving outward from a vehicle body; and
a position recognition unit configured to recognize a relative position of an obstacle with respect to the door based on a reflected wave of an ultrasonic wave transmitted from the sensor unit and reflected by the obstacle, wherein
the pair of transducers are arranged at a predetermined interval,
the sensor unit receives, by the pair of transducers, a reflected wave of an ultrasonic wave transmitted from at least one of the transducers toward a predetermined wave transmission area outside the vehicle body, and
the position recognition unit recognizes the relative position of the obstacle with respect to the door based on respective reflected waves received by the pair of transducers.

2. The obstacle recognition device according to claim 1, wherein
the pair of transducers are arranged on an outer peripheral portion of the door along an outer periphery of the door.

3. The obstacle recognition device according to claim 2, wherein
the pair of transducers are arranged on a lower edge of the outer peripheral portion of the door, and
the wave transmission area is set so as to overlap with an opening/closing area where the door moves by an opening/closing operation.

4. The obstacle recognition device according to claim 2, wherein
the pair of transducers are arranged on a lower edge of the outer peripheral portion of the door, and
the wave transmission area is set so as not to overlap with an area below an opening/closing area where the door moves by an opening/closing operation.

5. The obstacle recognition device according to claim 3, wherein
a transmission direction of each transducer is set so as to be inclined upward from a horizontal direction when viewed from the transducer.

6. A vehicle door with an obstacle recognition function, comprising:
a sensor unit including a pair of transducers of an ultrasonic wave; and
a position recognition unit configured to recognize a relative position of an obstacle based on a reflected wave of an ultrasonic wave transmitted from the sensor unit and reflected by the obstacle, wherein
the pair of transducers are arranged at a predetermined interval,
the sensor unit receives, by the pair of transducers, a reflected wave of an ultrasonic wave transmitted from at least one of the transducers toward a predetermined wave transmission area outside the vehicle body, and
the position recognition unit recognizes the relative position of the obstacle based on respective reflected waves received by the pair of transducers.
